(19) United States
(12) Patent Application Publication
(10) Pub. No.: US 2021/0326796 A1
(43) Pub. Date: Oct. 21, 2021

(54) SYSTEM AND METHOD FOR MANAGING, EVALUATING AND ASSIGNING INSTALLATION AND/OR REPAIR TECHNICIANS BASED ON CUSTOMER FEEDBACK

(71) Applicant: Hughes Network Systems, LLC, Germantown, MD (US)

(72) Inventor: Anurag BHATNAGAR, Germantown, MD (US)

(21) Appl. No.: 16/845,390

(22) Filed: Apr. 10, 2020

(51) Int. Cl. G06Q 10/06; G06F 16/23

(52) U.S. Cl. CPC G06Q 10/063112; G06F 16/2379

(57) ABSTRACT

A system for managing installation or repair technicians includes a technician mobile device and a central server. The central server includes a receiver, a memory, and a processor. The receiver is configured to receive from a customer mobile device at least one numerical rating of the first technician assigned by a first customer after completion of the first work order. The memory stores a technician database having a plurality of technician profiles. The processor is configured to access the technician database. The processor is also configured to execute instructions stored on the memory to: (i) update the technician database using the at least one numerical rating, and (ii) use the updated technician database for at least one of: (a) assigning a second technician to complete a second work order for the first customer; or (b) assigning the first technician to complete a third work order for a second customer.

### BACKGROUND

### Field of the Invention

The present disclosure generally relates to a system and method useful for managing, evaluating and assigning technicians who perform installation and/or repair work. In particular, the present disclosure relates to a system and method which manages and assigns technicians in a manner that creates the best experience possible for each customer.

### Background Information

In various industries, technicians are required to move from site to site and perform installation and repair work. For example, in the communications industry, technicians are regularly called to homes to install and/or repair satellite receivers, antennas, grounding connections, and other electronics equipment. The extent of the installation and repair work can vary from household to household, making some technicians better suited than others to attend to different tasks. Additionally, a wide variety of factors can lead to a customer viewing the technician's installation and/or repair work as either a positive or negative experience.

### SUMMARY

It has been discovered that an improved system and method of managing, evaluating and assigning technicians who perform installation and/or repair work is desired. In view of the state of the known technology, one aspect of the present disclosure is to provide a system for managing installation or repair technicians. The system includes a technician mobile device and a central server. The central server includes a receiver, a memory, and a processor. The receiver is configured to receive from a customer mobile device at least one numerical rating of the first technician assigned by a first customer after completion of the first work order. The memory stores a technician database having a plurality of technician profiles. The processor is configured to access the technician database. The processor is also configured to execute instructions stored on the memory to: (i) update the technician database using the at least one numerical rating, and (ii) use the updated technician database for at least one of: (a) assigning a second technician to complete a second work order for the first customer; or (b) assigning the first technician to complete a third work order for a second customer.

Another aspect of the present disclosure is to provide a method for managing installation or repair technicians. The method includes receiving, via a receiver, a first work order from a first customer; assigning, via a processor of a central server, a first technician to complete the first work order; receiving, via the receiver, a feedback survey from the first customer upon completion of the first work order by the first technician, the feedback survey including at least one numerical rating for the first technician; calculating, via the processor, at least one summary rating for the first technician using the at least one numerical rating; updating, via the processor, a technician database using the at least one summary rating for the first technician; and assigning, via the processor, a second technician to complete a second work order for the first customer based on the updated technician database or assigning, via the processor, the first technician to complete a third work order for a second customer based on the updated technician database.

Another aspect of the present disclosure is to provide another method for managing installation or repair technicians. The method includes receiving, via a receiver, a first work order from a first customer; assigning, via a processor of a central server, a first technician to complete the first work order; receiving, via the receiver, a feedback survey from the first customer upon completion of the first work order by the first technician, the feedback survey including at least one note written by the first customer regarding the first work order completed by the first technician; automatically processing, via the processor, the at least one note written by the first customer to determine whether the note includes at least one key word; and assigning, via the processor, a second technician to complete a second work order for the first customer based on the at least one key word or assigning, via the processor, the first technician to complete a third work order for a second customer based on the at least one key word.

### BRIEF DESCRIPTION OF THE DRAWINGS

Referring now to the attached drawings which form a part of this original disclosure:

FIG. 1 shows an example embodiment of a management, evaluation and/or assignment system in accordance with the present disclosure;

FIG. 2 shows an example embodiment of an installation and/or repair management method in accordance with the present disclosure;

FIG. 3 shows an example embodiment of a customer feedback method which can be performed as part of the installation and/or repair management method of FIG. 2;

FIG. 4 shows an example embodiment of a technician rating method which can be performed as part of the installation and/or repair management method of FIG. 2;

FIGS. 5A and 5B show example embodiments of technician databases in accordance with the present disclosure; and

FIG. 6 shows an example embodiment of a technician assignment method which can be performed as part of the installation and/or repair management method of FIG. 2.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

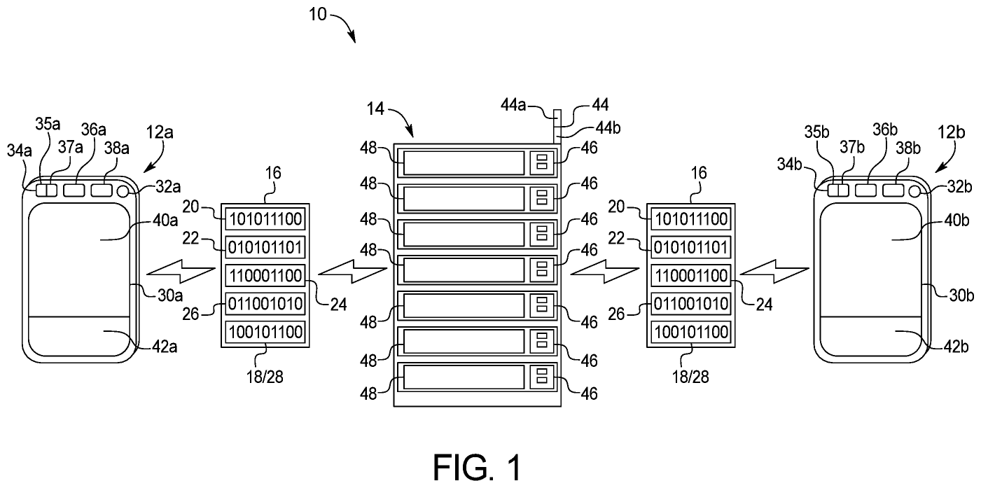

FIG. 1 illustrates an example embodiment of a management, evaluation and/or assignment system 10 according to the present disclosure. In the illustrated embodiment, the system 10 can include a customer mobile device 12a, a technician mobile device 12b, and a central server 14. In use, the customer mobile device 12a and the technician mobile device 12b can wirelessly communicate with central server 14 to transmit data packets 16 including work orders 20, technician feedback 22, one or more photographs 24, technician or customer notes 26 and/or other types of data 28 such as updated processing instructions 18 for running an application on a mobile device. In an embodiment, the customer mobile device 12a and the technician mobile device 12b only communicate with each other via the central server 14 as an intermediary to keep the customer and technician's personal contact information private.

The customer mobile device 12a can include a first user interface 30a, a first camera 32a, a first data transmission device 34a, a first processor 36a and a first memory 38a. In use, the first processor 36a is configured to execute instructions programmed into and/or stored by the first memory 38a. The instructions can be, for example, processing instructions 18 periodically received and/or updated via the data packets 16 received from the central server 14. Once the processing instructions 18 have been stored in the first memory 38a, the first processor 36a can then control the user interface 30a, the camera 32a and the data transmission device 34a based on the processing instructions 18.

The technician mobile device 12b can include a second user interface 30b, a second camera 32b, a second data transmission device 34b, a second processor 36b and a second memory 38b. In use, the second processor 36b is configured to execute instructions programmed into and/or stored by the second memory 38b. The instructions can be, for example, processing instructions 18 periodically received and/or updated via the data packets 16 received from the central server 14. Once the processing instructions 18 have been stored in the second memory 38b, the second processor 36b can then control the second user interface 30b, the second camera 32b and the second data transmission device 34b based on the processing instructions 18.

The customer and technician mobile devices 12a and 12b can be, for example, cellular phones, tablets, personal computers or other electronic devices. The first and second user interfaces 30a and 30b can each include respective display screens 40a and 40b and respective input devices 42a and 42b such as touch screens or button pads. The cameras 32a and 32b can be standard cameras configured to record still images and/or videos. The first and second data transmission devices 34a and 34b can each include, for example, a respective transmitter 35a, 35b and a respective receiver 37a, 37b configured to send and receive wireless signals.

The transmitters 35a, 37a can each be any known transmitter capable of sending a wireless signal (e.g., send outgoing electromagnetic waves such as radio waves), for example, by generating a radio frequency alternating current which is applied to an antenna. Likewise, the receivers 35b, 37b can each be any known receiver capable of receiving a wireless signal (e.g., receiving incoming electromagnetic waves such as radio waves), for example, which extracts information from a radio frequency alternating current which is received by an antenna, converting the radio frequency alternating current into a form useable by the first processor 36a of the customer mobile device 12a and/or the second processor 36b of the technician mobile device 12b. The transmitter 35a and the receiver 37a can be combined into a single transceiver and/or utilize or include a single antenna or separate antennas on the customer mobile device 12a, while the transmitter 35b and the receiver 37b can be combined into a single transceiver and/or utilize or include a single antenna or separate antennas on the technician mobile device 12b.

The central server 14 can include a third data transmission device 44, a third processor 46, and a third memory 48. In use, the third processor 46 is configured to execute instructions programmed into and/or stored by the third memory 48. The instructions followed by the third processor 46 can be control instructions which differ from the processing instructions 18 used by the mobile devices. The third processor 46 can also be configured to constantly update the processing instructions 18 and transmit the updated programing instructions 18 to the customer and/or technician mobile devices 12a and 12b via the third data transmission device 44, which can include, for example, a transmitter 44a and a receiver 44b configured to send and receive wireless signals.

The transmitter 44a can be any known transmitter capable of sending a wireless signal (e.g., send outgoing electromagnetic waves such as radio waves), for example, by generating a radio frequency alternating current which is applied to an antenna. Likewise, the receiver 44b can be any known receiver capable of receiving a wireless signal (e.g., receiving incoming electromagnetic waves such as radio waves), for example, which extracts information from a radio frequency alternating current which is received by an antenna, converting the radio frequency alternating current into a form useable by the third processor 48 of the central server 14. The transmitter 44a and the receiver 44b can be combined into a single transceiver and/or utilize or include a single antenna or separate antennas.

As discussed herein, the central server 14 transmitting, sending and/or receiving data to or from the customer mobile device 12a can refer to wireless communication between the third data transmission device 44 (e.g., the transmitter 44a and the receiver 44b) and the first data transmission device 34a (e.g., the transmitter 35a and the receiver 37a), while the central server 14 transmitting, sending and/or receiving data to or from the technician mobile device 12b can refer to wireless communication between the third data transmission device 44 (e.g., the transmitter 44a and the receiver 44b) and the second data transmission device 34b (e.g., the transmitter 35b and the receiver 37b). It should be understood that the transmitter 35a of the first data transmission device 34a transmits signals/data to the receiver 44b of the third data transmission device 44, and the transmitter 44a of the third data transmission device 44 transmits signals/data to the receiver 37a of the first data transmission device 34a. It should also be understood that the transmitter 35b of the second data transmission device 34b transmits signals/data to the receiver 44b of the third data transmission device 44, and the transmitter 44a of the third data transmission device 44 transmits signals/data to the receiver 37b of the second data transmission device 34b.

Various tasks performed according to the methods described herein can be stored as instructions on one or more of the first memory 38a, the second memory 38b and/or the third memory 48. The first processor 36a can execute instructions programmed on the first memory 38a, the second processor 36b can execute instructions programmed on the second memory 38b, and the third processor 46 can execute instructions programmed on the third memory 48. Those of ordinary skill in the art will recognize that certain steps described herein with respect to one processor/memory combination can be performed by another processor/memory combination. It should further be understood, however, that dividing the tasks in certain ways as described herein can improve various factors such as customer privacy, the processing speed of each processor 36a, 36b, 46, and/or the memory space used/available within each memory 38a, 38b, 48.

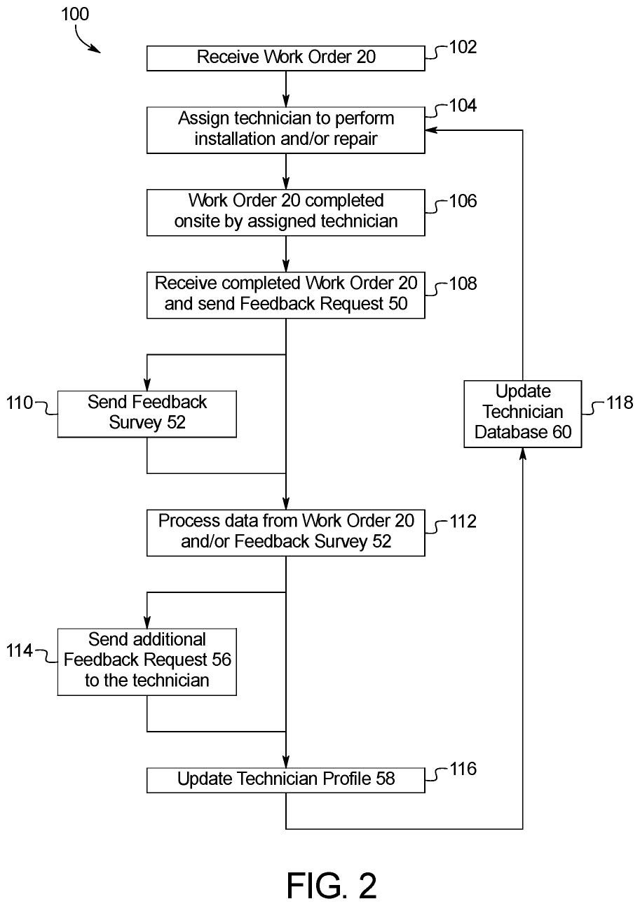

FIG. 2 illustrates an example embodiment of an installation and/or repair management method 100 according to the present disclosure. Some or all of the steps of method 100 can be stored as instructions on first memory 38a, second memory 38b and/or third memory 48 and can be respectively executed by first processor 36a, second processor 36b and/or third processor 46 in accordance with the instructions stored on first memory 38a, second memory 38b and/or third memory 48. It should be understood that some of the steps described herein can be reordered or omitted without departing from the spirit or scope of method 100.

Referring to step 102, a customer can begin method 100 by placing a work order 20, which is received by the central server 14. The customer can place the work order 20, for example, by requesting various installation and/or repair options using the first user interface 30a on the customer mobile device 12a. Alternatively, the customer can place the work order 20 via an internet website or a call center which then logs the work order 20 into the third memory 48 of the central server 14.

At step 104, the central server 14 processes the work order 20. The third processor 46 can review the work order 20 and access a technician database 60 stored by the third memory 48. Based on the specific installation and/or repair requested by the work order 20, the third processor 46 can assign an appropriate technician to perform the installation and/or repair. The central server 14 then sends a data packet 16 including the work order 20 to the technician mobile device 12b of the assigned technician, for example, by transmitting the data packet 16 from the transmitter 44a of the third data transmission device 44 to the receiver 37b of the second data transmission device 34b. The data packet 16 sent to the technician mobile device 12b can also include, for example, the customer's location, the type of work to perform, and/or updated processing instructions 18 to use by the technician mobile device 12b during completion of the work order 20. In an alternative embodiment, the central server 14 first sends a message to the technician mobile device 12b to confirm the assigned technician's availability and/or competency to perform the installation and/or repair requested by the work order 20, and then the central server 14 sends the data packet 16 including the work order 20 upon confirmation from the technician mobile device 12b that the assigned technician has accepted the assignment.

At step 106, the technician arrives onsite and performs the installation and/or repair detailed by work order 20. While onsite, and before, during and/or after the installation and/or repair is completed, the technician mobile device 12b can be used to take photographs 24 and/or notes 26 relating to the work order 20. Once the installation and/or repair from the work order 20 has been completed, the technician can verify completion via the technician mobile device 12b and transmit a data packet 16 including any photographs 24 and/or notes 26 back to the central server 14, for example, by transmitting the data packet 16 from the transmitter 35b of the second data transmission device 34b to the receiver 44b of the third data transmission device 44.

At step 108, the central server 14 receives confirmation of the completed work order 20 from the technician's mobile device 12b via the data packet 16 received by the third data transmission device 44. The central server 14 then processes the completed work order 20, photographs 24 and/or notes 26 and transmits a feedback request 50 to the customer mobile device 12a of the customer who requested the work order 20 at step 102, for example, by transmitting the feedback request 50 from the transmitter 44a of the third data transmission device 44 to the receiver 37a of the first data transmission device 34a. In an embodiment, the feedback request 50 can be in the form of a text message, email, or downloadable application. In another embodiment, the feedback request 50 can be part of a larger data packet 16 including the photographs 24 and/or notes 26 taken with the technician mobile device 12b. In an embodiment, the central server 14 can select one of a plurality of feedback requests 50 to transmit to the customer mobile device 12a based on natural language processing performed by the third processor 46 using the notes 26 received from the technician mobile device 12b.

If the customer declines or does not answer the feedback request 50 within a predetermined amount of time, the declination or nonanswer can be transmitted back to the receiver 44b of the central server 14 at step 112. If the customer agrees to provide feedback in response to the feedback request 50, the central server 14 can send a feedback survey 52 to the customer's mobile device 12a, for example, by transmitting the feedback survey 52 from the transmitter 44a of the third data transmission device 44 to the receiver 37a of the first data transmission device 34a. In an embodiment, the feedback survey 52 can be part of a larger data packet 16 including the photographs 24 and/or notes 26 taken with the technician mobile device 12b. In another embodiment, the feedback survey 52 can be in the form of a text message, email, or downloadable application. In a further embodiment, the downloadable application can gain access to the photographs 24 and/or notes 26 taken with the technician mobile device 12b and stored in the third memory 48 of the central server 14. In yet another embodiment, the central server 14 can select one of a plurality of feedback surveys 52 to transmit to the customer mobile device 12a based on natural language processing performed by the third processor 46 using the notes 26 received from the technician mobile device 12b.

At step 110, the customer can use the customer mobile device 12a to complete the feedback survey 52. In an embodiment, the feedback survey 52 can include one or more of: (i) a request for a numerical rating for the technician in one or more technician categories 54 (e.g. a 1-5 or other numerical rating for categories such as friendliness, work quality, timeliness, etc.); (ii) photographs 24 of the technician's installation and/or repair; (iii) notes 26 taken by the technician while performing the installation and/or repair; (iv) a request for additional photographs 24 taken by the customer; and/or (v) a request for additional notes 26 taken by the customer. Once the feedback survey 52 has been completed by the customer, the customer's responses can be transmitted back to the central server 14 via another data packet 16, for example, by transmitting the data packet 16 from the transmitter 35a of the first data transmission device 34a to the receiver 44b of the third data transmission device 44.

At step 112, the customer's answers to the feedback survey 52 are processed by the third processor 46 of the central server 14. The processing performed by the third processor 46 can include, for example, the use of one or more algorithms to assign an overall rating and/or one or more task or categorical ratings to the technician based on the customer's answers to the feedback survey 52. Example embodiments of the processing at step 112 are shown, for example, with reference to method 300 discussed below. If the customer has chosen not to provide feedback, the third processor can still analyze the completed work order 20 at step 112, for example, by associating the technician with the work completed and/or assigning the technician one or more neutral rating.

Optionally, at step 114, the customer's answers to the feedback survey 52 can trigger the central server 14 to send an additional technician feedback request 56 back to the technician mobile device 12b, for example, by transmitting the technician feedback request 56 from the transmitter 44a of the third data transmission device 44 to the receiver 37b of the second data transmission device 34b. The technician feedback request 56 can request that the technician provide any further notes 26 related any issues experienced onsite with the customer and/or work order 20 which could affect the customer's ratings using the feedback survey 52, and/or any other notes 26 regarding the customer and/or work order 20. In an embodiment, the technician can further be asked to provide a numerical rating for the customer in one or more areas (e.g. a 1-5 rating for categories such as friendliness, availability, etc.). Alternatively, the technician feedback request 56 can be completed by the technician using the technician mobile device 12b when the technician finalizes the work order 20 at step 106. The technician's answers to the feedback request 56 can then be sent from the transmitter 35b of the second data transmission device 34b to the receiver 44b of the third data transmission device 44.

At step 116, a technician profile 58 stored within the third memory 48 of the central server 14 can be updated based on the processed customer feedback survey 52, and optionally the additional feedback from the technician. The technician profile 58 can be updated, for example, by using the overall rating and/or one or more task or categorical ratings determined at step 112. Example embodiments of the processing at step 116 are shown, for example, with reference to method 300 discussed below.

At step 118, the individual technician profile 58 can be used to update a larger technician database 60 stored by the third memory 48. In an embodiment, the technician database 60 can include a plurality of technician profiles 58 which include, for example, overall ratings (T_{O}), overall task-specific ratings (e.g., T_{O1}, T_{O2} . . . T_{Om}), overall categorical rankings (e.g., T_{Of}, T_{Op}, T_{Os}, T_{Oq}, T_{Od}), a churn score (CS) and/or any other ratings for each technician employed and/or used to perform various work orders 20. Once the technician profile 58 has been updated within the technician database 60 of the third memory 48, the updated technician database 60 can be used by the third processor 46 to assign a technician the next time a work order 20 is received by central database at step 102.

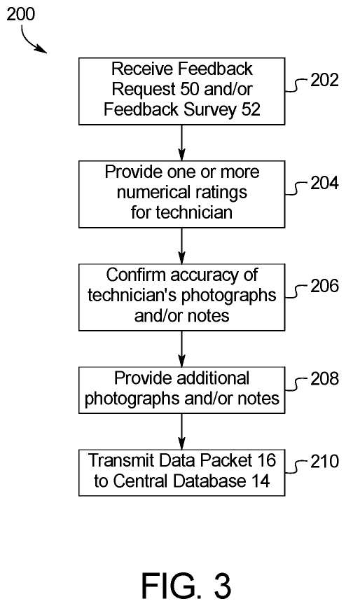

FIG. 3 illustrates an example embodiment of a customer feedback method 200 which can be performed using the customer mobile device 12a during steps 110 and/or 112 of method 100. Some or all of the steps of method 200 can be stored as instructions (e.g. processing instructions 18) on the first memory 38a and can be executed by the first processor 36a in accordance with the instructions stored on the first memory 38. It should be understood that some of the steps described herein can be reordered or omitted without departing from the spirit or scope of method 200.

At step 202, the customer mobile device 12a receives a feedback request 50 from the central server 14, for example, via a data packet 16 sent from the transmitter 44a of the third data transmission device 44 to the receiver 37a of the first data transmission device 34a. In an embodiment, the feedback request 50 can be in the form of a text message, email, or via downloadable application. In another embodiment, the feedback request 50 can be part of a larger data packet 16 including the photographs 24 and/or notes 26 taken with the technician mobile device 12b. If the customer agrees to provide feedback, then the customer mobile device 12a receives a feedback survey 52 from the central server 14. Alternatively, the customer mobile device 12a can receive the feedback survey 52 without ever having received a feedback request 50. Like with the feedback request 50, the feedback survey 52 can be in the form of a text message, email, or via downloadable application, and/or can be part of a larger data packet 16 including the photographs 24 and/or notes 26 taken with the technician mobile device 12b.

At step 204, the customer can provide one or more numerical ratings for the technician in technician categories 54 which cover a number of areas. For example, the ratings for various technician categories 54 can include the following: (i) a friendliness rating, R_{f}, e.g. relating to the overall mood/attitude of the technician while onsite; (ii) a punctuality rating, Rₚ, e.g. relating to the technician arriving onsite at the time provided during or after the work order 20 was placed; (iii) a speed of installation/repair rating, Rₛ, e.g. relating to the time taken by the technician to perform the entire work order 20 and/or specific installation and/or repair tasks relevant to the work order 20; (iv) a quality of installation/repair rating, R_{q}, e.g., relating to the customer's interpretation of the quality of the entirety of the completed work and/or individual installation/repair tasks; (v) an incidental damage incurred rating, R_{d}, e.g. relating to damage to the premises caused by the technician while onsite; and/or (vi) any other rating, Rₒ, determined to be useful for evaluating the work of the technician. Additionally, the customer can be requested to specify which of the one or more technician categories 54 is most important to the customer and/or provide additional notes 26 related to the ratings.

In an embodiment, the work order 20 can include multiple tasks. For example, one task can involve installation of a satellite receiver or antenna, while another task can involve making electrical connections. In an embodiment, the customer can provide one or more numerical ratings as discussed above for each task of an overall installation/repair process (e.g., rate the speed of each task, quality of each task, etc.). The customer can also record individual notes 26 related to separate tasks.

At step 206, the customer mobile device 12a can display one or more photographs 24 and/or notes 26 taken by the technician mobile device 12b while the technician was onsite performing the installation and/or repair. Using the customer mobile device 12a, the customer can confirm the accuracy of the technician's photographs 24 and/or notes 26. The customer can also log additional notes 26, for example, regarding perceived inaccuracies relating the technician's photographs 24 and/or notes 26.

In an embodiment, the customer mobile device 12a can display one or more photographs 24 and/or notes 26 taken by the technician mobile device 12b based on ratings by the customer at step 204. For example, if the customer gives the technician a low rating for quality of installation/repair, R_{Q}, the customer mobile device 12a can display one or more of the technician's photographs 24 of the installation/repair and ask the customer to point out where the quality was deficient. In another embodiment, if the customer gives the technician a low rating for quality of a specific portion of the repair, (e.g., R_{Q1}, R_{Q2} . . . R_{Qn} relating to an antenna installation, specific connection of components, etc.), the customer mobile device 12a can display only the technician's photographs 24 of that specific task and ask the customer to point out where the quality was deficient.

At step 208, the customer can take additional photographs 24 and/or notes 26 related to completion of the work order 20. The additional photographs 24 and/or notes 26 can be taken at the customer's discretion using the first camera 32a and/or first user interface 30a, and/or the additional photographs 24 and/or notes 26 can be requested as part of the feedback survey 52 based on ratings by the customer at step 204 and/or feedback by the customer at step 206. For example, if the customer indicates that a photograph 24 viewed at step 206 is inaccurate, the customer can use the first camera 32a to provide a new photograph which the customer believes is accurate. In another example, if the customer gives the technician a low rating for incidental damage incurred, RD, (e.g., incidental damage caused by the technician not related to the work order 20, dirt or mud tracked onsite, etc.), the customer mobile device 12a can request that the customer provide a photograph 24 and/or notes 26 showing the additional damage caused onsite.

At step 210, the customer completes the feedback survey 52 and transmits a data packet 16 including one or more photographs 24, notes 26 and/or other types of data 28 back to the central server 14, for example, by transmitting the data packet 16 from the transmitter 35a of the first data transmission device 34a to the receiver 44b of the third data transmission device 44. Optionally, referring to step 114 of method 100, the central server 14 can then transmit an additional technician feedback request 56 to the technician mobile device 12b, for example, by transmitting the technician feedback request 56 from the transmitter 44a of the third data transmission device 44 to the receiver 37b of the second data transmission device 34b. For example, if the customer has given the technician a low rating for punctuality, RP, or speed of installation/repair, R_{S}, the technician can be allowed to provide a reason for delay. In another example, the technician can use the technician mobile device 12b to view and/or comment on the additional photographs 24 and/or notes 26 provided by the customer at step 208.

In an embodiment, the feedback survey 52 can also ask the customer if they would like the same technician or a different technician to return if additional work is needed. The feedback survey 52 can also ask if the customer intends to use the same company for future work, allowing the company to determine whether a specific technician's actions have costed the company a customer, which can be useful in determining a churn score (Cs) as discussed below.

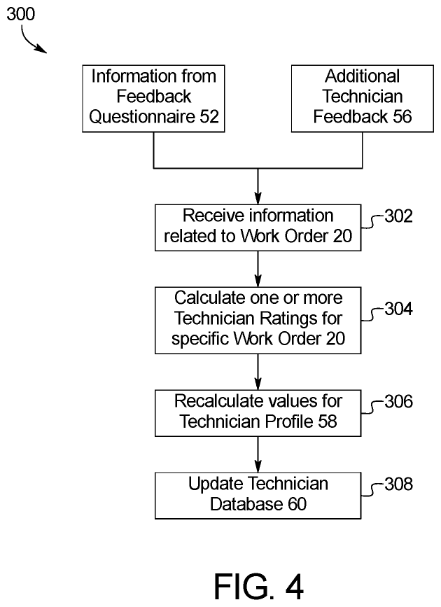

FIG. 4 illustrates an example embodiment of a technician rating method 300 which can be performed at steps 112, 116 and/or 118 of method 100. Some or all of the steps of method 200 can be stored as instructions on the third memory 48 and can be executed by the third processor 46 in accordance with the instructions stored on the third memory 48. It should be understood that some of the steps described herein can be reordered or omitted without departing from the spirit or scope of method 300.

At step 302, the central server 14 receives the ratings provided by the customer using the customer mobile device 12a in response to the feedback survey 52, for example, by receiving data related to the feedback survey 52 transmitted from the transmitter 35a of the first data transmission device 34a to the receiver 44b of the third data transmission device 44. Optionally, the central server 14 can also receive additional feedback from the technician using the technician mobile device 12b, which can be combined with the ratings provided by the customer and stored by the third memory 48 for further processing. The additional feedback from the technician can be transmitted, for example, from the transmitter 35b of the second data transmission device 34b to the receiver 44b of the third data transmission device 44.

At step 304, the third processor 46 calculates one or more technician ratings using the processing instructions stored by the third processor 46. For example, the third processor 46 can calculate a total project rating for the technician, T_{R}, using the following algorithm:

$${T}_{R} = \frac{( W 1 ⨯ R 1 ) + ( W 2 ⨯ R 2 ) + … ( Wn ⨯ Rn )}{( number of categories rated )} \qquad ( Equation 1 )$$

With Equation 1, R₁, R₂ . . . Rₙ represent individual ratings for n number of categories, and W₁, W₂ . . . Wₙ represent weights applied to each rating category. The weights can be any number. In an embodiment, the weights can be numbers between and including zero (0) and (1) (e.g., 0≤W≤1), which will cause the total project rating for the technician, T_{R}, to be on the same numerical scale as the individual ratings (e.g., 1-5). Thus, using the above technician categories 54, an example embodiment of Equation 1 can be the following algorithm:

$${T}_{R} = \frac{( Wf ⨯ Rf ) + ( Wp ⨯ Rp ) + ( Ws ⨯ Rs ) + ( Wq ⨯ Rq ) + ( Wd ⨯ Rd ) + ( Wo ⨯ Ro )}{6}$$

The above example is based on the example categories disclosed with respect to the technician categories 54 described herein, wherein R_{f} is a rating for technician friendliness, Rₚ is a rating for technician punctuality, Rₛ is a rating for the technician's speed of installation/repair, R_{q} is a rating for the technician's quality of installation/repair, R_{d} is a rating based on additional incidental damage caused by the technician onsite, and Rₒ is any other rating deemed useful for evaluating the work of the technician. Additionally, in the above embodiment, W_{f} is a friendliness weight, Wₚ is a punctuality weight, Wₛ is a speed weight, W_{q} is a quality weight, W_{d} is a damage weight, and W₀ is a weight for another category deemed useful for evaluating the work of the technician. It should be understood by those of ordinary skill in the art that this is an example only and that more or less ratings/weights can be used.

In an embodiment, the weights can be predetermined by the processing instructions stored by the third memory 48 based on whichever categories are deemed to be most important from the customer evaluation. In another embodiment, the weights can be altered based on feedback from the customer or technician. That is, if the customer or technician provides a reason that one or more category should be rated higher or lower than one or more other categories, the weights can reflect the reason. For example, if the technician received a low rating for speed of installation/repair, but the customer or technician provides a reason that the speed was slower in this particular instance, this factor can be reflected by lowering Wₛ in relation to other weights.

In an embodiment in which a work order 20 includes multiple tasks (e.g., the first task is to install a satellite receiver or antenna, the second task is to connect two components, etc.), the feedback survey 52 can include individual ratings for each of m number if tasks. In this embodiment, the third processor 46 can calculate an individual rating T_{R1}, T_{R2} . . . T_{Rm} for each task, for example, using the following algorithms:

$$\begin{matrix}{T}_{R 1} = \frac{( W 11 ⨯ R 11 ) + ( W 12 ⨯ R 12 ) + … ( W 1 n ⨯ R 1 n )}{( number of categories rated )} & ( Equation 2 ) \\ {T}_{R 2} = \frac{( W 21 ⨯ R 21 ) + ( W 22 ⨯ R 22 ) + … ( W 2 n ⨯ R 2 n )}{( number of categories rated )} & ( Equation 3 ) \\ {T}_{R m} = \frac{( Wm 1 ⨯ Rm 1 ) + ( Wm 2 ⨯ Rm 2 ) + … ( Wmn ⨯ Rmn )}{( number of categories rated )} & ( Equation 4 )\end{matrix}$$

With Equations 2-4, R₁₁, R₁₂ . . . R₁ₙ represent individual ratings for n number of categories related to a first task, R₂₁, R₂₂ . . . R₂ₙ represent individual ratings for n number of categories related to a second task, and Rₘ₁, Rₘ₂ . . . Rₘₙ represent individual ratings for n number of categories related to an mth task. Likewise, W₁₁, W₁₂ . . . W₁ₙ represent weights applied to each rating category for the first task, W₂₁, W₂₂ . . . Wₘₙ represent weights applied to each rating category for the second task, and Wₘ₁, Wₘ₂ . . . Wₘₙ represent weights applied to each rating category for the mth task. The weights can be any number. In an embodiment, the weights can be numbers between and including zero (0) and (1) (e.g., 0≤W≤1), which will cause the total task ratings for the technician, T_{R1}, T_{R2} . . . T_{Rm}, to be on the same numerical scale as the individual ratings (e.g., 1-5). Thus, using the above technician categories 54, an example embodiment of Equation 2 may be the following algorithm:

$${T}_{R 1} = \frac{( Wf 1 ⨯ Rf 1 ) + ( Wp 1 ⨯ Rp 1 ) + ( Ws 1 ⨯ Rs 1 ) + ( Wq 1 ⨯ Rq 1 ) + ( Wd 1 ⨯ Rd 1 ) + ( Wo 1 ⨯ Ro 1 )}{6}$$

$${T}_{R 2} = \frac{( Wf 2 ⨯ Rf 2 ) + ( Wp 2 ⨯ Rp 2 ) + ( Ws 2 ⨯ Rs 2 ) + ( Wq 2 ⨯ Rq 2 ) + ( Wd 2 ⨯ Rd 2 ) + ( Wo 2 ⨯ Ro 2 )}{6}$$

$${T}_{Rm} = \frac{( Wfm ⨯ Rfm ) + ( Wpm ⨯ Rpm ) + ( Wsm ⨯ Rsm ) + ( Wqm ⨯ Rqm ) + ( Wdm ⨯ Rdm ) + ( Wom ⨯ Rom )}{6}$$

By using multiple overall ratings T_{R1}, T_{R2} . . . T_{Rm} for each of m tasks, the third processor 46 can evaluate the strengths and weaknesses of each individual technician in relation to different projects and use those strengths and weaknesses to evaluate the technicians for future work orders 20.

At step 306, the third processor 46 can access a technician profile 58 within the third memory 48 and recalculate a technician's overall rating, T_{O}, using the ratings from step 304. The overall rating, To, can be calculated, for example, using the following equation:

$${T}_{O} = \frac{TR + ( Previous Technician Rating )}{( total number of ratings )} \qquad ( Equation 5 )$$

Similarly, the third processor 46 can access a technician profile 58 within the third memory 48 and recalculate a technician's individual ratings for individual tasks (e.g., T_{O1}, T_{O2} . . . T_{Om}) to evaluate the technician's strengths and weaknesses with respect to different tasks. The overall ratings, T_{O1}, T_{O2} . . . Tom, can be calculated, for example, using the following equation:

$${{T}_{O 1}}^{=} \frac{TR 1 + ( Previous Technician Rating for Task 1 )}{( total number of ratings )}$$

$${T}_{O 2} = \frac{TR 2 + ( Previous Technician Rating for Task 2 )}{( total number of ratings )}$$

$${T}_{O m} = \frac{TRm + ( Previous Technician Rating for Task m )}{( total number of ratings )}$$

Using the same or similar equations, the third processor 46 can also calculate overall ratings for the technician categories 54 (e.g., T_{Of}, T_{Op}, T_{Os}, T_{Oq}, T_{Od}) by combining the new ratings for the technician categories 54 from the feedback survey 52 with past ratings for the technician categories 54 from previous feedback surveys 52.

Once a new overall rating, To, and/or individual ratings for individual tasks (e.g., T_{O1}, T_{O2} . . . T_{Om}) have been recalculated, the third processor 46 can update the technician database 60 stored by the third memory 48 at step 308. In an embodiment, the technician can be allowed to view the increase and or decrease to the overall rating, To, and/or individual ratings for individual tasks (e.g., T_{O1}, T_{O2} . . . T_{Om}) or other categorical ratings and provide an explanation prior to the technician database 60 being updated. In an embodiment, each technician is required to complete a minimum number of work orders 20 before being added to and/or updated with the technician database 60 to prevent a small number of work orders 20 from skewing the ratings.

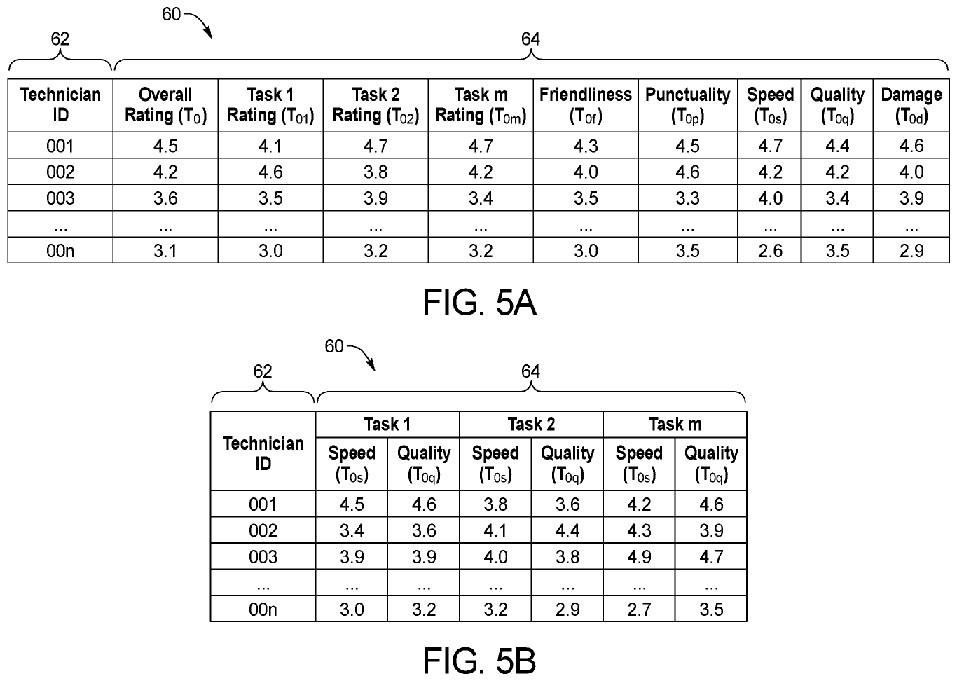

FIGS. 5A and 5B illustrate example embodiments of how one or more technician database 60 can be structured. Those of ordinary skill in the art should recognize that these are examples only, and that more or less information can be included in a technician database 60 stored by the third memory 48 of the central server 14. Referring to FIG. 5A, a technician database 60 can include a technician identifier 62 and a plurality of numerical ratings 64. In the illustrated embodiment, the plurality of numerical ratings 64 include overall rating (T_{O}), various individual task ratings (T_{O1}, T_{O2} . . . T_{Om}), and various individual category ratings (T_{Of}, T_{Op}, T_{Os}, T_{Oq}, T_{Od}). Referring to FIG. 5B, which can be included as part of the same technician database 60 as the information from FIG. 5A, a technician database 60 can further include individual category ratings separated for different tasks (e.g., different installation/repair projects organized by type, or different subparts of installation/repair projects).

One or more technician databases 60 such as those shown in FIGS. 5A and 5B can be useful for a number of reasons. In one embodiment, the technician database(s) 60 can be used to assign a technician to new work orders 20. In another embodiment, the technician database(s) 60 can be used in a churn analysis to develop a correlation between a low ranking and loss of a customer's business.

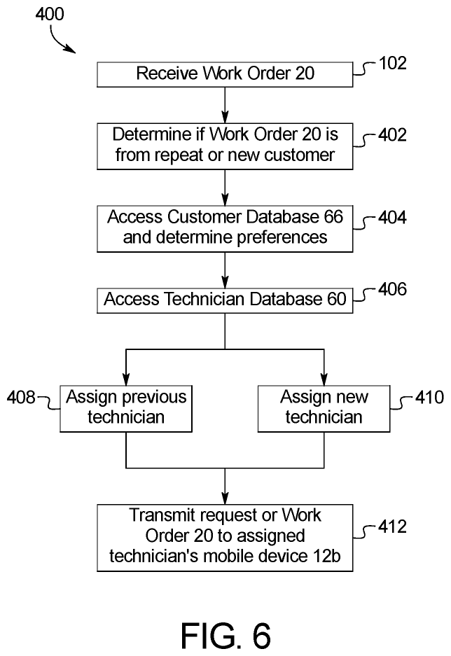

FIG. 6 illustrates an example embodiment a technician assignment method 400 which can be performed at step 104 of method 100. Some or all of the steps of method 400 can be stored as instructions on the third memory 48 and can be executed by the third processor 46 in accordance with the instructions stored on the third memory 48. It should be understood that some of the steps described herein can be reordered or omitted without departing from the spirit or scope of method 400.

At step 402, the central server 14 receives a work order 20 which has been requested by a customer, for example, in accordance with step 102 above. In an embodiment, the central server 14 can receive the work order 22, for example, by receiving data related to the work order 22 transmitted from the transmitter 35a of the first data transmission device 34a to the receiver 44b of the third data transmission device 44. The third processor 46 can then access a customer database 66 stored within the third memory 48 to determine whether the customer is a repeat customer or a new customer.

At step 404, the third processor 46 can determine whether a repeat customer has any known preferences relating to specific technicians and/or categories. This can be determined, for example, based on how the customer responded to one or more feedback surveys 52 during past installations/repairs. The third processor 46 can determine, for example, that a particular customer tends to value speed over quality, or punctuality over friendliness, etc. The third processor 46 can also review the ratings that the customer has given to specific technicians in the past.

In an embodiment, the third processor 46 can use notes from past feedback surveys 52 by a repeat customer to determine any known preferences relating to specific technicians and/or categories. In an embodiment, the third processor 46 can use natural language processing of previous customer notes 26, either at the time the feedback surveys 52 are initially received and/or at the time the repeat customer initiates a new work order 20, to determine any known preferences relating to specific technicians and/or categories. For example, the third processor 46 can detect a word such as “slow” in previous notes 26 to determine that the previous customer complained about the speed of the previous work; in this case, the third processor 46 can prioritize speed when assigning a new technician (e.g., weigh the technicians' speed ratings within technician database 60 more heavily). In another example, the third processor 46 can detect a word such as “late” in previous notes 26 to determine that the previous customer complained about the punctuality of the previous technician; in this case, the third processor 46 can prioritize punctuality when assigning a new technician (e.g., weigh the technicians' punctuality ratings within technician database 60 more heavily). In another example, the third processor 46 can detect a word such as “rude” in previous notes 26 to determine that the previous customer complained about the friendliness of the previous technician; in this case, the third processor 46 can prioritize friendliness when assigning a new technician (e.g., weigh the technicians' friendliness ratings within technician database 60 more heavily). Those of ordinary skill in the art will recognize other terms and categories to use when determining customer preferences. Using these and other preferences of a specific customer, the third processor 46 can constantly build and update the customer database 66 when the feedback surveys 52 are received and/or at the time a repeat customer initiates a new work order 20 to reflect the customer's preferences.

At step 406, the third processor 46 can review the technician database 60 for the purpose of assigning a specific technician to perform the work order 20. In an embodiment, the third processor 46 can narrow the technician database 60 based on the technicians' work schedules and ability to perform specific tasks specified by the work order 20.

If the received work order 20 involves the repair of a previous project performed by a specific technician indicated to be available by the technician database 60, the third processor 46 at step 408 can assign that same technician to perform the repair. In an embodiment, the same technician will have had to receive at least a minimum rating (e.g., a minimum overall rating or minimum categorical ratings) by the customer in response to the previous installation to be allowed to return to the customer's house for the repair. Likewise, if the work order 20 involves a new installation for a previous customer, the third processor 46 can proceed to step 408 and assign a same technician from a prior installation as long as that technician received at least a minimum rating by the customer for the prior work.

At step 410, a new technician can be assigned to perform the work order 20, for example, in cases of: (i) a new customer; (ii) a returning customer who rated a previous technician below a minimum score or previously indicated that the same technician should not return; or (iii) a previous technician unavailable or unable to perform the new work order 20. When selecting a new technician, the third processor 46 can review the technician database 60 to determine the best technician to assign based on the customer and/or the work order.

In an embodiment, the third processor 46 can use the specific work assigned by the work order 20 to assign a technician. The third processor 46 can make this assignment by performing a mathematical analysis of the data within the technician database 60 in view of the tasks assigned by the work order 20. For example, referring to FIG. 5A, if a work order 20 involves each of tasks 1, 2 . . . n, then the third processor 46 can assign the work order 20 to Technician ID 001, who has the best overall rating for those three tasks. Alternatively, if a work order 20 only requires task 1 to be performed, then Technician ID 002 can be assigned over Technician ID 001, because Technician ID 002 has the best rating for task 1 even if not the best overall rating. Thus, the third processor 46 can use one or more value within the technician database 60 to choose the ideal technician for the specific situation.

In another embodiment, the customer preferences determined at step 404 can be considered when assigning a technician. For example, if the customer complained about a technician's friendliness in the past, the third processor 46 can give more weight to the friendliness rating (T_{Of}) in comparison to other ratings. Likewise, if the customer complained about a technician's quality of installation/repair in the past, the third processor 46 can give more weight to the quality rating (T_{Oq}) in comparison to other ratings. The same is true for the rest of the categories. Further, referring to FIG. 5B, the third processor 46 can use specific ratings for specific tasks to assign the ideal technician for a work order 20. For example, if the work order 20 only involves task 2 and the customer values speed and/or quality, the third processor 46 can determine Technician ID 002 to be the ideal technician based on ratings for task 2, regardless of whether Technician 001 is better overall.

By assigning technicians based on the specific tasks of the work order 20 and the customer's known preferences from customer database 66, the third processor 46 can assist in ensuring that the customer has the best experience possible when the installation/repair is performed.

At step 412, once the appropriate technician has been assigned, the central server 14 can send a request and/or work order 20 to the assigned technician's mobile device 12b, so that the assigned technician can then proceed onsite and complete the work (e.g., in accordance with step 106 of method 100). The request and/or work order 20 can be sent, for example, from the transmitter 44a of the third data transmission device 44 to the receiver 37b of the second data transmission device 34 of the assigned technician's mobile device 12b.

The third processor 46 can also use the technician database 60 in a churn analysis, for example, to determine which technicians are retaining and/or losing customers. This information can be used to make hiring/firing and/or salary/bonus decisions, thus rewarding the top technicians for their efforts. In an embodiment, the third processor 46 can track whether customers remain with a company and/or leave for competitors within a given amount of time after each work order 20 is completed. Based on customers remaining or leaving, each technician profile 58 within the technician database 60 can include a churn score (C_{S}), for example, wherein a higher churn score indicates a high number of customers remaining with the company and/or increasing business with the company after visits from the technician, and wherein a lower churn score indicates a high number of customers leaving within a certain amount of time after visits from the technician.

The third processor 46 can use the technician's churn score to ensure that high-profile customers are serviced by the technicians most likely to retain or increase business. In an embodiment, when assigning a technician to a work order 20 for a high-profile customer, the third processor 46 can select only from technicians in the technician database who meet a minimum churn score and/or can weigh the technician's churn scores more heavily when making the assignment.

The embodiments described herein provide improved systems and methods for managing, evaluating and assigning technicians who perform installation and/or repair work. The improved systems and methods manage and assign technicians in a manner that creates the best experience possible for each customer. It should be understood that various changes and modifications to the systems and methods described herein will be apparent to those skilled in the art and can be made without diminishing the intended advantages.

### General Interpretation of Terms

In understanding the scope of the present invention, the term “comprising” and its derivatives, as used herein, are intended to be open ended terms that specify the presence of the stated features, elements, components, groups, and/or steps, but do not exclude the presence of other unstated features, elements, components, groups, integers and/or steps. The foregoing also applies to words having similar meanings such as the terms, “including”, “having” and their derivatives. Also, the terms “part,” “section,” or “element” when used in the singular can have the dual meaning of a single part or a plurality of parts. Accordingly, these terms, as utilized to describe the present invention should be interpreted relative to a connecting device.

The term “configured” as used herein to describe a component, section or part of a device includes hardware and/or software that is constructed and/or programmed to carry out the desired function.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A system for managing installation or repair technicians, the system comprising:
a technician mobile device configured to be operated by a first technician during completion of a first work order;
a central server including a receiver configured to receive from a customer mobile device at least one numerical rating of the first technician assigned by a first customer after completion of the first work order, a memory storing a technician database having a plurality of technician profiles, and a processor configured to access the technician database,
the processor configured to execute instructions stored on the memory to: (i) update the technician database using the at least one numerical rating, and (ii) use the updated technician database for at least one of: (a) assigning a second technician to complete a second work order for the first customer; or (b) assigning the first technician to complete a third work order for a second customer.

2. The system of claim 1, wherein the at least one numerical rating includes at least one of: (i) a friendliness rating; (ii) a punctuality rating; (iii) a speed rating; (iv) a quality rating; or (v) an incidental damage rating.

3. The system of claim 1, wherein the at least one numerical rating includes a plurality of ratings related to different tasks performed by the first technician during completion of the first work order.

4. The system of claim 1, wherein the technician mobile device includes a camera to record at least one photograph during completion of the first work order, the at least one photograph made accessible to the first customer while the first customer assigns the at least one numerical rating.

5. The system of claim 1, wherein the at least one numerical rating includes a plurality of numerical ratings, the central server assigning a weight to at least one of the plurality of numerical ratings when updating the technician database.

6. The system of claim 1, wherein the receiver is configured to receive from the customer mobile device at least one note composed by the first customer, the processor configured to analyze the at least one note for at least one key word and use the at least one key word when causing at least one of: (a) assignment of the second technician to complete the second work order for the first customer; or (b) assignment of the first technician to complete the third work order for the second customer.

7. The system of claim 1, wherein the central server is configured to wirelessly communicate with the technician mobile device for subsequent feedback after the receiver receives the at least one numerical rating from the customer mobile device, the processor configured to apply a weight to the at least one numerical rating based on the subsequent feedback prior to updating the technician database.

8. The system of claim 1, wherein the receiver is configured to receive from the customer mobile device at least one note composed by the first customer, the processor configured to analyze the at least one note for at least one key word and use the at least one key word to create a customer profile for use in assigning one of a plurality of technicians from the technician database upon placement of a second work order by the first customer.

9. A method for managing installation or repair technicians, the method comprising:
receiving, via a receiver, a first work order from a first customer;
assigning, via a processor of a central server, a first technician to complete the first work order;
receiving, via the receiver, a feedback survey from the first customer upon completion of the first work order by the first technician, the feedback survey including at least one numerical rating for the first technician;
calculating, via the processor, at least one summary rating for the first technician using the at least one numerical rating;
updating, via the processor, a technician database using the at least one summary rating for the first technician; and
assigning, via the processor, a second technician to complete a second work order for the first customer based on the updated technician database or assigning, via the processor, the first technician to complete a third work order for a second customer based on the updated technician database.

10. The method of claim 9, wherein the at least one numerical rating includes at least one of: (i) a friendliness rating; (ii) a punctuality rating; (iii) a speed rating; (iv) a quality rating; or (v) an incidental damage rating.

11. The method of claim 9, wherein the at least one numerical rating includes a plurality of ratings related to different tasks performed by the first technician during completion of the first work order.

12. The method of claim 9, further including receiving, via the receiver, at least one photograph recorded by the first technician during completion of the first work order, and transmitting, via a transmitter of the central server, the at least one photograph to the first customer with the feedback survey.

13. The method of claim 9, wherein the at least one numerical rating includes a plurality of numerical ratings, the method further including assigning, via the processor, a weight to at least one of the plurality of numerical ratings when calculating the at least one summary rating for the first technician.

14. The method of claim 9, further including receiving, via the receiver, at least one note composed by the first customer upon completion of the first work order, analyzing, via the processor, the at least one note for at least one key word, and assigning, via the processor, a second technician to complete a second work order for the first customer based on the updated technician database or assigning, via the processor, the first technician to complete a third work order for a second customer based on the updated technician database.

15. The method of claim 9, further including receiving, via the receiver, subsequent feedback from the first technician after receiving the at least one numerical rating from the first customer, and applying, via the processor, a weight to the at least one numerical rating based on the subsequent feedback when calculating the at least one summary rating.

16. The method of claim 9, further including receiving, via the receiver, at least one note composed by the first customer upon completion of the first work order, analyzing, via the processor, the at least one note for at least one key word, creating, via the processor, a customer profile based on the at least one key word, and assigning, via the processor, one of a plurality of technicians upon placement of a second work order by the first customer based on the customer profile.

17. A method for managing installation or repair technicians, the method comprising:
receiving, via a receiver, a first work order from a first customer;
assigning, via a processor of a central server, a first technician to complete the first work order;
receiving, via the receiver, a feedback survey from the first customer upon completion of the first work order by the first technician, the feedback survey including at least one note written by the first customer regarding the first work order completed by the first technician;
automatically processing, via the processor, the at least one note written by the first customer to determine whether the note includes at least one key word; and
assigning, via the processor, a second technician to complete a second work order for the first customer based on the at least one key word or assigning, via the processor, the first technician to complete a third work order for a second customer based on the at least one key word.

18. The method of claim 17, further including creating a customer profile, via the processor, using the at least one key word, the customer profile for use by the processor in assigning the second technician upon placement of the second work order by the first customer.

19. The method of claim 17, further including predicting loss of the customer, via the processor, using the at least one key word.

20. The method of claim 17, further including receiving, via the receiver, at least one numerical rating for the first technician along with the at least one note.
